(19) United States
(12) Patent Application Publication
(10) Pub. No.: US 2026/0093828 A1
(43) Pub. Date: Apr. 2, 2026

(54) TASK PROCESSING METHOD AND DEVICES AND ELECTRONIC DEVICE

(71) Applicant: Lenovo (Beijing) Limited, Beijing (CN)

(72) Inventor: Binsheng QUE, Beijing (CN)

(21) Appl. No.: 19/337,406

(22) Filed: Sep. 23, 2025

(30) Foreign Application Priority Data
Sep. 30, 2024 (CN) 2024113912610

(51) Int. Cl. G06F 21/60; G06F 21/62; G06F 40/30

(52) U.S. Cl. CPC G06F 21/604; G06F 21/6254; G06F 40/30

(57) ABSTRACT

A task processing method includes obtaining a target task when an electronic device is in a first operating state and a target application is active, where the target application calls a target model to respond to the target task; and in response to the target task, outputting an output result for the target task by the target application. The output result corresponds to a security level of the electronic device in the first operating state. The security level of the electronic device in the first operating state is lower than a security level of the electronic device in a second operating state.

### CROSS-REFERENCE TO RELATED APPLICATION

This application claims priority of Chinese Patent Application No. 2024113912610, filed on Sep. 30, 2024, the entire contents of which are hereby incorporated by reference.

### FIELD OF THE DISCLOSURE

The present disclosure generally relates to the field of applications involving generative large models and, more particularly, relates to a task processing method, a task processing device, and an electronic device.

### BACKGROUND

In recent years, with the development and application of artificial intelligence (AI) technology, electronic devices, including mobile phones and laptops have become increasingly capable and intelligent. Electronic devices can utilize AI algorithms to automatically generate content aligned with user intentions. For example, a generative artificial intelligence (AIGC) model can be invoked to query and summarize trending news, generate product promotion videos, or conduct conversations with users. The capabilities greatly facilitate users'daily activities and work.

To ensure a security of an electronic device and user's sensitive data, the above task processing method may only be executed when the electronic device is in an unlocked screen state. Once the electronic device enters a locked screen state, the electronic device is prevented from outputting content that meets the user's intentions as described above, which may prevent the electronic device from fulfilling user's task processing needs.

### BRIEF SUMMARY OF THE DISCLOSURE

One aspect of the present disclosure provides a task processing method. The task processing method includes obtaining a target task in response to an electronic device being in a first operating state and a target application being active, the target application calling a target model to respond to the target task; and responding to the target task and outputting an output result for the target task by the target application. The output result corresponds to a security level of the electronic device in the first operating state. The security level of the electronic device in the first operating state is lower than a security level of the electronic device in a second operating state.

Another aspect of the present disclosure provides an electronic device. The electronic device includes one or more processors and at least one memory containing computer program instructions for executing a target application. When executing the computer program instructions, the one or more processors are configured to perform: obtaining a target task in response to an electronic device being in a first operating state and a target application being active, the target application calling a target model to respond to the target task; and in response to the target task, outputting an output result for the target task by the target application. The output result corresponds to a security level of the electronic device in the first operating state; and the security level of the electronic device in the first operating state is lower than a security level of the electronic device in a second operating state.

Another aspect of the present disclosure provides a non-transitory computer readable storage medium containing computer program instructions for executing a target application. When executing the computer program instructions, at least one processor is configured to perform: obtaining a target task in response to an electronic device being in a first operating state and a target application being active, the target application calling a target model to respond to the target task; and in response to the target task, outputting an output result for the target task by the target application. The output result corresponds to a security level of the electronic device in the first operating state; and the security level of the electronic device in the first operating state is lower than a security level of the electronic device in a second operating state.

Other aspects of the present disclosure can be understood by a person skilled in the art in light of the description, the claims, and accompanying drawings of the present disclosure.

### BRIEF DESCRIPTION OF THE DRAWINGS

The above and other features, advantages, and aspects of various embodiments of the present disclosure will become more apparent from the following detailed description, taken in conjunction with the accompanying drawings. Throughout the accompanying drawings, same or similar reference numbers refer to same or similar elements. It is understood that the accompanying drawings are schematic and are not necessarily drawn to scale with respect to the components and elements shown.

FIG. 1 illustrates a flowchart of a task processing method provided in Embodiment 1 of the present disclosure;

FIG. 2 illustrates a flowchart of a task processing method provided in Embodiment 2 of the present disclosure;

FIG. 3 illustrates a flowchart of a task processing method provided in Embodiment 3 of the present disclosure;

FIG. 4 illustrates a flowchart of a task processing method provided in Embodiment 4 of the present disclosure;

FIG. 5 illustrates a flowchart of a task processing method provided in Embodiment 5 of the present disclosure;

FIG. 6 illustrates a flowchart of a task processing method provided in Embodiment 6 of the present disclosure;

FIG. 7 illustrates a flowchart of a task processing method provided in Embodiment 7 of the present disclosure;

FIG. 8 illustrates a flowchart of a task processing method provided in Embodiment 8 of the present disclosure;

FIG. 9 illustrates a schematic diagram of a task processing device provided in Embodiment 1 of the present disclosure;

FIG. 10 illustrates a schematic diagram of a task processing device provided in Embodiment 2 of the present disclosure;

FIG. 11 illustrates a schematic diagram of a task processing device provided in Embodiment 3 of the present disclosure;

FIG. 12 illustrates a schematic diagram of a task processing device provided in Embodiment 4 of the present disclosure;

FIG. 13 illustrates a schematic diagram of a hardware structure of an electronic device provided in Embodiment 1 of the present disclosure; and

FIG. 14 illustrates a schematic diagram of a hardware structure of an electronic device provided in Embodiment 2 of the present disclosure.

### DETAILED DESCRIPTION

The embodiments of the present disclosure are described below with reference to the accompanying drawings. Terms used in the embodiments are intended solely to explain specific embodiments and do not limit the scope of the present disclosure. It will be understood by a person skilled in the art that, with the advancement of technology and the emergence of new scenarios, technical solutions provided by the embodiments of the present disclosure may also be applicable to similar technical problems.

Terms “first”, “second”, and the like, as used in the description, claims and accompanying drawings of the present disclosure, are employed solely to distinguish similar elements and are not intended to indicate any specific order or sequence. The terms may be used interchangeably under appropriate circumstances and are merely intended to differentiate elements with similar attributes in the embodiments of the present disclosure. Furthermore, terms “include” and “comprise” and any variations thereof, are intended to encompass non-exclusive inclusions. Accordingly, a process, method, system, product or apparatus that includes a series of elements is not limited to the elements but may also include other elements not expressly listed or inherent to such process, method, system, product, or apparatus.

To address the above issues, the embodiments of the present disclosure provide a task processing method that enables a target application to invoke a target model to respond to a target task and fulfill a user's task processing needs when an electronic device is in a low-security operating state, such as a screen lock state. Meanwhile, the method ensures that the output result of the electronic device for the target task corresponds to a lower security level.

Under the lower security level, the processing content of the target task is restricted to prevent the output of sensitive user or device information, or other predetermined important data. Accordingly, the method maintains security while fulfilling task processing needs and improving the user experience. A detailed description of the task processing method according to an embodiment of the present disclosure will be provided below with reference to the accompanying drawings.

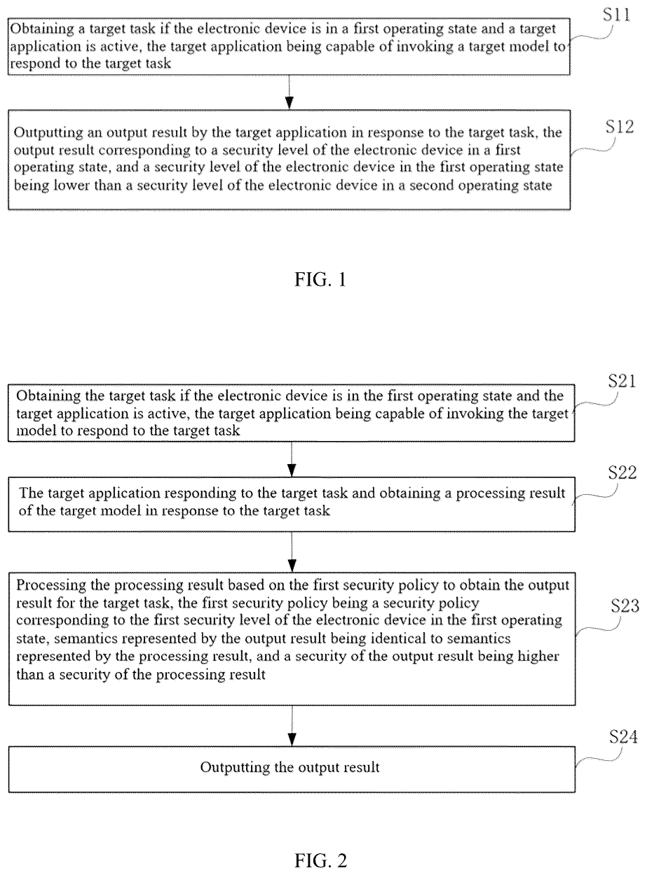

FIG. 1 illustrates a flowchart of a task processing method provided in Embodiment 1 of the present disclosure. The method may be applied to user terminals of various product types, including but not limited to smartphones, tablets, wearable devices, augmented reality (AR) or virtual reality (VR) devices, laptops, or other electronic display devices. As illustrated in FIG. 1, the task processing method may include the following steps.

S11: obtaining a target task if the electronic device is in a first operating state and a target application is active, the target application being capable of invoking a target model to respond to the target task.

In Embodiment 1, with the advancement of artificial intelligence technology, the target model may include a large AI model, such as a generative artificial intelligence (GAI) model, an artificial intelligence-generated content (AIGC) model, a large model (LM), a large language model (LLM), or other machine learning or deep learning models trained to perform specific target tasks using one or more AI algorithms. The present disclosure does not limit a type of the target model or a method by which the target model is obtained.

Preferably, the present disclosure employs a large AI model, as described above, as the target model. The electronic device is a user terminal arranged with necessary software and hardware resources to support an execution or invocation of the large AI model. When it is determined that the obtained target task requires calling the large AI model, the resources can reliably support a model's response to the target task. By selecting the AI large model as the target model, the method fully utilizes the target model's intelligence, comprehensiveness, and high-accuracy content generation capabilities, thereby addressing diverse task processing needs and enhancing both the variety and precision of task outputs. Embodiment 1 does not elaborate on specific implementation processes of various large AI models for different target tasks, and the target model used by the electronic devices is not limited to a large AI model.

When the target model is a large AI model as described above, the target task that requires invoking the model may include one or more content generation tasks, such as creating text, images, videos, audio, or software code. Examples include product design drawing tasks, character, scene, and storyline generation for game development, and summarization of thematic content. The present disclosure does not limit a scope of the target task or a method by which the target task is obtained. It should be understood that the target task is not limited to the content generation tasks described above and may also include question-and-answer tasks, control tasks, and others, as determined based on the user's actual needs and device usage scenarios.

Based on the above analysis, the target application in the present disclosure may be an AI-based intelligent assistant configured to detect user input on an electronic device, identify user intent based on an input, and determine a corresponding target task. Examples include various voice assistants integrated into terminal devices produced by major manufacturers. When a user desires to perform a target task using the electronic device, a voice signal reflecting the user's intent may be provided as input. A voice assistant may recognize the intent conveyed by the voice signal, determines the target task, and may further determine whether invocation of the target model is required to respond to the target task. The present disclosure does not elaborate on internal working principles of the AI-based intelligent assistant.

It should be noted that not all user-requested tasks require invocation of the target model. For certain tasks, such as control tasks involving an operation of smart home devices or applications such as music software, the target application may respond without invoking the target model. The target application identifies control intent and can directly activate corresponding software on the electronic device to generate an output result consistent with the control intent. For example, the target application may initiate a music application to play a specific song. Alternatively, the control task may utilize a communication link between the electronic device and a smart home device to transmit control instructions, which allows the smart home device to execute operations corresponding to the control intent, such as directing a robotic vacuum to clean a specified area or activating an air conditioner in a designated room to operate at a specified temperature.

S12: outputting an output result by the target application in response to the target task, the output result corresponding to a security level of the electronic device in a first operating state, and a security level of the electronic device in the first operating state being lower than a security level of the electronic device in a second operating state.

As described above, although security levels corresponding to different operating states of the electronic device (e.g., a first operating state and a second operating state) may vary, the electronic device can still satisfy the user's task processing needs. Therefore, a user does not need to manually switch the electronic device to a specific operating state (such as the second operating state, which includes the unlocked screen state) to complete the target task, which enhances a flexibility of user control over the electronic device, broadens a range of applicable task scenarios, and improves a convenience of user input operations.

However, when the electronic device is in the first operating state corresponding to a lower security level, it is desirable to enhance a security of the output result and reduce a risk of privacy leakage caused by responding to the target task. Therefore, in Embodiment 1, when the electronic device is in different operating states, the target application may output different results for a same target task based on the security level corresponding to a current operating state. Accordingly, the user's task processing needs are met while maintaining the security of the output result to the greatest extent possible.

For convenience of description, the security level of the electronic device in the first operating state is referred to as a first security level, and a security level of the electronic device in the second operating state is referred to as a second security level. The second security level is higher than the first security level. Based on the above analysis, a usage environment of the electronic device under the first security level is less secure than a usage environment of the electronic device under the second security level. Therefore, when the electronic device is in the first operating state to perform the target task requested by a user, stricter security requirements are imposed on the output result of the target task. In response to the target task, when obtaining the output result for the target task, a suitable processing method may be employed to ensure that the output result corresponds to the first security level and satisfies the security requirements associated with the first security level.

Based on the above analysis, when the electronic device is in the first operating state, although the first security level is lower than the second security level, the target application executed by the electronic device may still directly respond to the target task. During a target task response process, the target application may invoke the target model to process the target task, leveraging a target model's comprehension and content generation capabilities to obtain content used for determining the output result for the target task. The output result may be generated in a manner that satisfies output security requirements corresponding to the first security level. As a result, the output result is secure, reliable, and meets the user's task processing needs. Furthermore, in scenarios where the electronic device is lost or stolen, and an unauthorized user attempts to initiate a target task, execution of the method described in Embodiment 1 may prevent output or leakage of private content to the greatest extent possible.

In one potential implementation, the target application can determine whether to invoke the target model in response to the target task by analyzing processing intent of the target task, for example, based on an implementation method of the target task configured by the electronic device. Alternatively, determination may be made based on a task type of the target task. Various task types that require invocation of the target model may be pre-configured, and whether the target model needs to be invoked may be determined by detecting if the target task corresponds to one of the pre-configured task types. In addition, during a process of obtaining the target task, intent recognition may be performed on user input information to determine whether invoking the target model is necessary to respond to the target task. The present disclosure does not limit the method used to determine whether the target model needs to be invoked during the target task response process, nor does the present disclosure limit a manner in which the target model is invoked to respond to the target task. The above operations may be implemented based on pre-configured control logic of the electronic device.

To summarize, in a scenario where a user requests the electronic device to automatically perform the target task, even if the electronic device is in the first operating state, and a current first security level is lower than the second security level corresponding to the second operating state, there is no need for the user to switch the electronic device to the second operating state. The target application can directly respond to the target task and output the output result while in the first operating state, thereby meeting the user's task processing needs, enhancing a diversity of responses to the target task, ensuring that the output result corresponds to the first security level, improving a security of responses to the target task, and reducing a risk of private content leakage when outputting the output result under a lower security level.

For example, if the first operating state of the electronic device is the locked screen state and the second operating state is the unlocked screen state, when the electronic device is in the locked screen state, a user may input task request information for a target task—such as voice signals like “What are the schedules for today?” or “What new messages are there in the mailbox?”. As described above in the task processing method proposed in Embodiment 1, the AI intelligent assistant (i.e., the target application) in an operating state performs intent recognition on a voice signal input by the user and determines a corresponding response task, which satisfies a user's intention is a target task that needs to be implemented by invoking the AI large model (i.e. a target model), without requiring the user to unlock the electronic device. When the electronic device is in the locked screen state, the AI intelligent assistant can automatically invoke the AI large model to respond to the target task, for example, by processing pre-stored schedule or mailbox content and outputting today's agenda or pending email summaries, while ensuring that the output result conforms to a security level of the electronic device in the locked screen state. The above approach reduces a risk of information leakage that may result from directly outputting sensitive user data, such as important travel times and locations, personal phone numbers, identity information, internal company data, or other private content in emails, thereby enhancing both the security and diversity of task processing.

FIG. 2 illustrates a flowchart of a task processing method provided in Embodiment 2 of the present disclosure. To further enhance a security of the output content, Embodiment 2 proposes adding a security processing step for the content to be output before executing an output step, based on the task processing method described above. As shown in FIG. 2, the task processing method proposed in Embodiment 2 may include the following steps.

S21: obtaining the target task if the electronic device is in the first operating state and the target application is active, the target application being capable of invoking the target model to respond to the target task.

S22: the target application responding to the target task and obtaining a processing result of the target model in response to the target task.

In conjunction with relevant descriptions of the target application, target model, and target task provided in the Embodiment 1, when the target task requires invocation of the target model for execution, the target application may invoke the target model through a corresponding application programming interface (API), so that the target model responds to the target task and obtains a corresponding processing result of the target task. The above response process may be carried out based on the type of the target task and a task processing logic configured for the target model. The present disclosure does not limit a specific implementation manner by which the target model responds to the target task.

In one potential implementation, the target model may be a large-scale AI model, such as a generative AI application or an AI-generated content (AIGC) model. To enhance the accuracy and stability of the large AI model and to ensure that the processing result of the large AI model aligns with a user's intent (i.e., an intended outcome in response to the target task), the present disclosure may incorporate prompt engineering techniques (also referred to as contextual information). Specifically, by optimizing a prompt (input instruction) corresponding to the target task, a behavior of the large AI model can be guided to generate the processing result for the target task.

Based on the above, during a process in which the target application invokes the target model to respond to the target task, task prompt information corresponding to the target task may be determined based on user input information. The task prompt information is provided to the target model to guide a response to the target task. For example, the task prompt information may enable the target model to interpret content of the target task and, in accordance with the processing logic corresponding to the target task content indicated by the task prompt information, generate an appropriate processing result for the target task.

For example, if a user inputs a voice signal such as “What's new in the mailbox?”, the AI intelligent assistant performs intent recognition and determines that the target task is to summarize an email content the user intends to read. A client of the AI large model may be invoked to access the email in a user's mailbox that is logged in on the electronic device. Based on the email content to be read, the AI large model can construct summary prompt information using a predefined prompt template for summarizing the email content. According to the summary processing logic indicated by the summary prompt word contained in the summary prompt template, the large AI model interprets and summarizes the email content to be read, thereby generating a summary result of the email content, that is, the processing result of the target model in response to the target task.

It should be noted that based on the above description of the target task and the target model, a process of obtaining the processing result of the target model in response to the target task includes but is not limited to the content generation process described above. In a potential implementation, the obtained target task or a task description content or task keywords thereof can be directly input into the target model. By leveraging the robust processing capabilities of the target model, the processing result for the target task can be generated directly.

For example, a user inputs a voice signal “How is the weather in Beijing today?” to initiate a weather query task for retrieving current weather conditions in Beijing. The target model receives either a description of the weather query task or extracts task keywords such as “today,” “Beijing,” and “weather” from the input. The target model can query today's weather data for Beijing from the Meteorological Bureau database and use the retrieved weather data as the processing result for the weather query task. Alternatively, the weather data can be incorporated into a weather query result generated using a statement template.

It can be seen that, for target tasks of different types or contents, the target model may adopt different processing logic when responding to each target task. The present disclosure does not limit a specific implementation method of step S22. The processing logic can be configured or adjusted as needed to optimize how the target model responds to various target tasks, thereby improving the accuracy and reliability of the processing result. In addition, the input content and sources of the input content used by the target model during a response to the target task include, but are not limited to, information that has already been obtained by the electronic device or can be accessed but has not yet been retrieved. The input content may include data stored locally or entered directly on the electronic device, as well as data obtained from external sources, such as databases, servers, or other internet-connected terminal devices, through communication with the electronic device, depending on a specific scenario.

S23: processing the processing result based on the first security policy to obtain the output result for the target task, the first security policy being a security policy corresponding to the first security level of the electronic device in the first operating state, semantics represented by the output result being identical to semantics represented by the processing result, and a security of the output result being higher than a security of the processing result.

S24: outputting the output result.

In combination with the above description of the process for obtaining the processing result, the processing result generated by the target model in response to the target task may include private content that requires protection. If the processing result is directly output as the output result for the target task, there is a risk of privacy leakage, particularly if the electronic device is lost or stolen, since the electronic device in the first operating state can execute the task processing method described in Embodiment 2. To mitigate the risk of private content leakage, Embodiment 2 proposes applying additional security processing to the processing result generated by the target model, thereby enhancing a security of the output result.

Therefore, the processing result obtained in Embodiment 2 may be further processed according to the first security policy, such that the semantics represented by the output result for the target task remain consistent with the semantics represented by the original processing result, thereby ensuring that the output result still fulfills the user's target task requirement. The output result obtained after processing the processing result based on the first security policy has a higher security level than the original processing result. When the processing result contains private content, the processing result may be processed based on the first security policy such that the resulting output no longer includes the private content. The electronic device outputs the output result in the first operating state without causing a security issue related to a leakage of private content.

The first security policy corresponds to the first security level of the electronic device in the first operating state. The first security policy may be configured based on security requirements for the output result, as indicated by the first security level, to ensure that the processing result is handled in accordance with the first security policy and that the obtained output result complies with the corresponding security level. The present disclosure does not limit the content of the first security policy.

In one potential implementation, in a scenario where a determined or invoked sensitive lexicon represents private content that requires protection, the first security policy may include a filtering policy based on the sensitive lexicon. During implementation of step S23, the obtained processing result may be processed based on the filtering policy of the sensitive lexicon. Specifically, the processing result is filtered to remove sensitive words that match entries in the sensitive lexicon, such as various types of user identity information and device identification data. As a result, the output result no longer contains sensitive information.

Compared with the processing result generated by the target model in response to the target task, the security of the output result is improved after being processed according to the filtering policy.

In one potential implementation, the first security policy may further include an anonymization processing policy. For private content requiring anonymization, such as user and identity information included in the processing result generated by the target model in response to the target task, information masking may be performed. The information masking may include filtering or blocking user and identity information or replacing the user information and identity information with pre-configured secure values or placeholder symbols (e.g., “XXX” or “XX”) to generate a more secure output result. Therefore, when the output result is provided, the device and user information associated with the electronic device is no longer present, thereby protecting private content including the device and user information. The private content requiring anonymization may be determined based on applicable privacy protection laws or internal corporate data protection policies. The present disclosure does not limit content of the anonymization policy, or a method used to identify the private content.

In one potential implementation, the processing result obtained by the target model in response to the target task can be further processed using a privacy protection policy based on differential privacy technology. Specifically, the processing result is processed by adding randomized noise data of a same type to blur the processing result, thereby achieving a purpose of protecting private content. Optionally, each sentence in the processing result can be converted into a word embedding vector. Laplacian noise is added to each word embedding vector to generate perturbed word embedding vectors. Subsequently, an original sentence is replaced with a sentence corresponding to a nearest neighbor vector of the perturbed word embedding vector, which may be identified, for example, using the Euclidean distance metric. The above process avoids directly outputting the original sensitive sentence and thereby achieves privacy protection.

In practical applications, the first security policy may include, but is not limited to, the three policies described above. One or more of the three polices may be reasonably selected and combined to form the first security policy, based on the security requirements indicated by the first security level for the electronic device in the first operating state, to output the output result for the target task. After obtaining the processing result generated by the target model in response to the target task, the processing result is processed according to the first security policy. For example, user information such as a user's name, phone number, address, social media account, and/or work unit information included in the processing result may be blocked, along with other information such as corporate confidential information, bank transaction records, and other undisclosed property data. As a result, the processed processing result no longer contains the blocked private contents. Accordingly, the security of the output result for the target task is higher than the security of the processing result directly obtained by the target model.

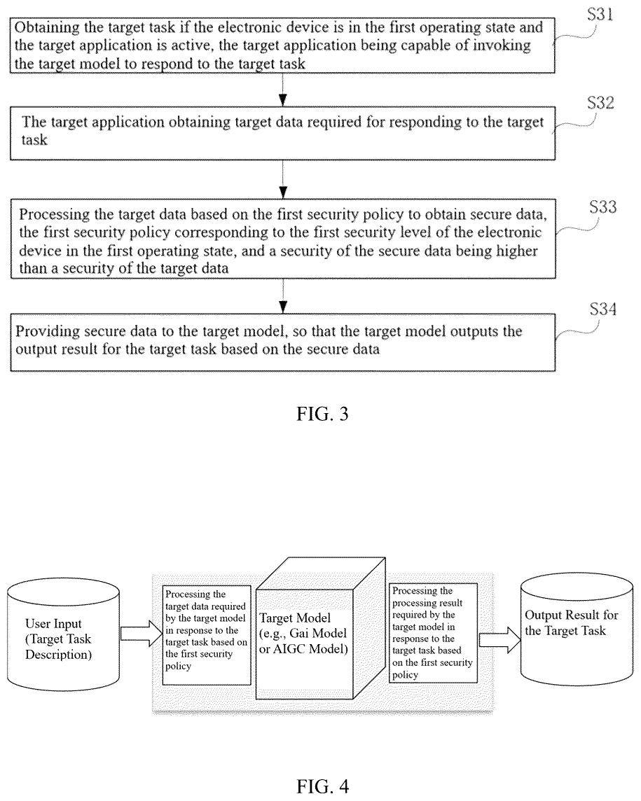

FIG. 3 illustrates a flowchart of a task processing method provided in Embodiment 3 of the present disclosure. To further enhance the security of the output result, based on the task processing method described above, Embodiment 3 proposes introducing a security processing step prior to a step in which the target application responds to the target task. The security processing step addresses the privacy content embedded in the input to the target model, which, if not handled in advance, may cause the electronic device in the first operating state to generate the output result for the target task that contains the private content, thereby leading to privacy leakage.

Based on the above, as shown in FIG. 3, the task processing method proposed in Embodiment 3 may include the following steps.

S31: obtaining the target task if the electronic device is in the first operating state and the target application is active, the target application being capable of invoking the target model to respond to the target task.

S32: the target application obtaining target data required for responding to the target task.

S33, processing the target data based on the first security policy to obtain secure data, the first security policy corresponding to the first security level of the electronic device in the first operating state, and a security of the secure data being higher than a security of the target data.

In combination with the above description of the target application invoking the target model in response to the target task, in a scenario where the target task is to summarize email content to be read, the target data obtained in Embodiment 3 may include the email content to be read from a user's mailbox such as email body content and attachment content, as well as email summary instructions, which may be obtained based on an analysis of a voice signal input by an user or a similar input. The email content to be read may include, but is not limited to, the private content described above. If the target data is directly provided to the target model to respond to the target task, the output result may easily contain private content. If the electronic device is lost, stolen, or used unlawfully, directly outputting results such as email content summaries may lead to serious security and privacy breaches.

To address the issue of security and privacy leakage, Embodiment 3 proposes that, after obtaining the target data required for the target task, the target data be processed based on the first security policy to generate secure data with enhanced protection. The processed secure data is provided to the target model for subsequent operations. In conjunction with the description of the first security policy, if the target data contains sensitive words from, or matches entries in, a sensitive lexicon, a filtering policy based on the sensitive lexicon can be applied. The first security filters and removes any sensitive words from the target data, ensuring that the resulting secure data no longer contains sensitive words or matches the sensitive lexicon, thereby enhancing the data security before the target data is input into the target model.

If the target data contains private content that requires anonymization, such as user information and device information, the user information and device information in the target data can be blocked according to an anonymization policy. Obtained secure data should exclude private content. If the security requirement at the first security level is particularly high, a privacy protection policy based on differential privacy can be applied. The privacy protection policy involves adding random noise to the target data to obscure content of the target data, thereby protecting the private content in the target data. As a result, the obtained secure data will no longer contain the original private content, enhancing the security of the secure data.

It can be understood that the first security policy, corresponding to the first security level used in Embodiment 3, may include, but is not limited to, the various policies described above. For example, the first security policy may involve anonymizing the target data, filtering the anonymized data using a sensitive lexicon. Specifically, after removing punctuation from the anonymized data, a deterministic finite automaton (DFA) algorithm can be applied to identify and block sensitive words from the sensitive lexicon. Differential privacy processing is applied to the target data after the sensitive words are masked, resulting in secure data that maximizes security. To ensure accuracy of the output result, the content of the first security policy can be selected appropriately during execution. For example, if the privacy protection policy based on differential privacy is not applied, semantics of the secure data will remain identical to semantics of the target data, which guarantees that the target model responds correctly to the target task, and that the output result meets the processing needs of the user requesting the target task.

It should be noted that a sensitive lexicon used in each policy within the first security policy, as well as the private content to be anonymized, can be customized or adjusted according to user's specific security requirements. A detailed implementation process is not covered in the present disclosure. Optionally, for each of the above security policies, a corresponding filter or security check model can be configured to enforce the policy on the input target data, thereby preventing private content from being sent to the target model and avoiding generation of the output result that contain private content.

S34: providing secure data to the target model, so that the target model outputs the output result for the target task based on the secure data.

With respect to the implementation process in which the target application invokes the target model, transmits the obtained secure data to the target model, and the target model analyzes the target data to generate the output result for the target task, reference may be made to the relevant description in Embodiment 2, which is not repeated herein.

In Embodiment 3, when the electronic device is in the first operating state and the target application is active, if the target task is received, the target application can still invoke the target model to respond to the target task even if a current first security level of the electronic device is lower than the second security level of the electronic device in the second operating state. In the above implementation process, after obtaining the target data required to respond to the target task, Embodiment 3 processes the target data according to the first security policy to generate secure data having a higher security level than the original target data. The secure data is provided to the target model to respond to the target task. Compared to a scenario in which the target model directly responds to the target task based on the unprocessed target data, Embodiment 3 responds to the target task based on secure data, thereby improving the security of the output result for the target task. The present disclosure is no longer limited to invoking the target model only when the electronic device is in the second operating state, thereby improving task processing diversity and increasing user convenience in achieving the target task.

In some embodiments, when the target model responds to the target task based on secure data, the obtained processing result can be further processed according to the first security policy to obtain the output result for the target task. Referring to the flow chart shown in FIG. 4, Embodiment 4 provides secure processing for both the target data required to respond to the target task and the processing result generated by the target model. In other words, double-layer security is applied to both input and output content of the target model based on the first security policy. The comprehensive processing operation reliably prevents the output result for the target task from containing private content, thereby ensuring the security of the output result generated by the electronic device in the first operating state. The dual-layer security processing can be implemented in conjunction with the corresponding steps described in Embodiments 2 and 3, which are not repeated herein.

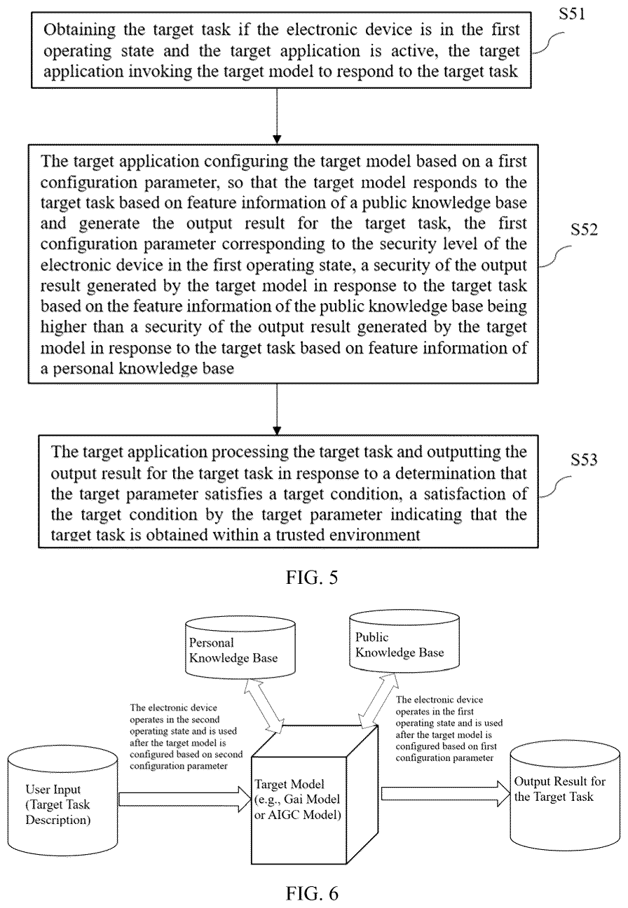

FIG. 5 illustrates a flowchart of a task processing method provided in Embodiment 5 of the present disclosure. Embodiment 5 describes an optional refined implementation in which the target application invokes the target model to respond to the target task, as described in the preceding embodiments. For example, the target model may respond to a refined implementation of the target task based on an existing knowledge base. Other steps of the task processing method may follow the descriptions provided in the relevant embodiments and are not repeated herein. Based on the above, and as illustrated in FIG. 5, the task processing method proposed in Embodiment 5 may include the following steps.

S51: obtaining the target task if the electronic device is in the first operating state and the target application is active, the target application being capable of invoking the target model to respond to the target task.

S52: the target application configuring the target model based on a first configuration parameter, so that the target model responds to the target task based on feature information of a public knowledge base and generate the output result for the target task, the first configuration parameter corresponding to the security level of the electronic device in the first operating state, a security of the output result generated by the target model in response to the target task based on the feature information of the public knowledge base being higher than a security of the output result generated by the target model in response to the target task based on feature information of a personal knowledge base.

S53: outputting the output results for the target task.

In Embodiment 5, the public knowledge base refers to a collection of knowledge shared within an organization, enterprise or society. The public knowledge base is typically maintained and accessed by a plurality of users and may be constructed and managed using tools including knowledge management systems, content management systems, databases, and search engines. The public knowledge base typically includes knowledge assets of the organization or enterprise, industry standards, public data sets, encyclopedias, and similar resources. The personal knowledge base refers to a collection of knowledge, information, experience, and skills accumulated by an individual user to enhance work efficiency and support personal development. The personal knowledge base can be constructed and maintained using tools such as note-taking software, personal databases, cloud storage services, and the like. The personal knowledge base typically includes user's personal notes, documents, project-related materials, learning resources, personal experiences, and other related content.

Accordingly, the public knowledge base is characterized by openness, sharing, and standardization, whereas the personal knowledge base is characterized by personalization, privacy, and flexibility. As a result, a security level of feature information within the public knowledge base is generally higher than a security level of feature information within the personal knowledge base. Outputting feature information of the public knowledge base typically does not pose privacy leakage risks, while outputting feature information of the personal knowledge base may introduce potential privacy leakage risks.

Based on the above, Embodiment 5 proposes that when the electronic device is in the first operating state and the target model is invoked to respond to the target task, to improve the security of the output result, the target model may respond to the target task based on the feature information of the public knowledge base. To achieve the task processing, the first configuration parameter corresponding to the first security level of the electronic device in the first operating state can be determined to implement the task processing method. Therefore, when the target model needs is invoked to respond to the target task, the target model can be configured based on the first configuration parameter, so that the configured target model utilizes feature information of the public knowledge base to generate the output result for the target task. The content of the output result either directly originates from the public knowledge base or is derived from the feature information of the public knowledge base or is generated based on the feature information. Since the feature information of the public knowledge base does not contain private content, a risk of privacy leakage due to private content being introduced into the output result from the knowledge base is effectively avoided, thereby enhancing the security of the output result.

FIG. 6 illustrates a flowchart of a task processing method provided in Embodiment 6 of the present disclosure. When the electronic device is in the second operating state and the target application invokes the target model to respond to the target task, since the electronic device is currently at a higher second security level, a request to implement the target task is typically initiated by an owner of the electronic device. Therefore, the target model may be allowed to query the personal knowledge base to respond to the target task and generate the output result accordingly. To implement the task processing method, a second configuration parameter corresponding to the second security level of the electronic device in the second operating state can be determined in advance. The second configuration parameter differs from the first configuration parameter. The present disclosure does not limit contents of the configuration parameters, nor methods for determining or implementing the configuration parameters.

Subsequently, when the electronic device is in the second operating state and the target task is obtained, the target model is invoked to respond to the target task based on the feature information of the personal knowledge base. As illustrated in FIG. 6, the output result for the target task is generated, and may be directly output. To enhance output security, the target model obtains the processing result in response to the target task based on the feature information of the personal knowledge base, processes the processing result according to the second security policy corresponding to the second security level, generate and outputs the output result for the target task. It can be understood from the above descriptions of the first and second security levels that a security processing intensity applied to the processing result under the first security policy is equal to or greater than a security processing intensity applied to the processing result under the second security policy. The present disclosure does not limit the content of the second security policy, which may include, for example, filtering strategies based on sensitive lexicons.

In other embodiments, when the target model responds to the target task based on feature information of a knowledge base such as the personal knowledge base or public knowledge base described above, user input information (e.g., the target data) may also be processed according to a security policy corresponding to the security level of the electronic device. Privacy content contained within the user input information can be identified and masked or shielded to prevent the output result generated in response to the target task from including the privacy content or related private information, thereby enhancing the security of the output result. The present disclosure may further process data at the input and output ends of the target model based on corresponding security policies as described above, thereby reliably preventing the output result for the target task from containing privacy content and effectively ensuring the security of the output result.

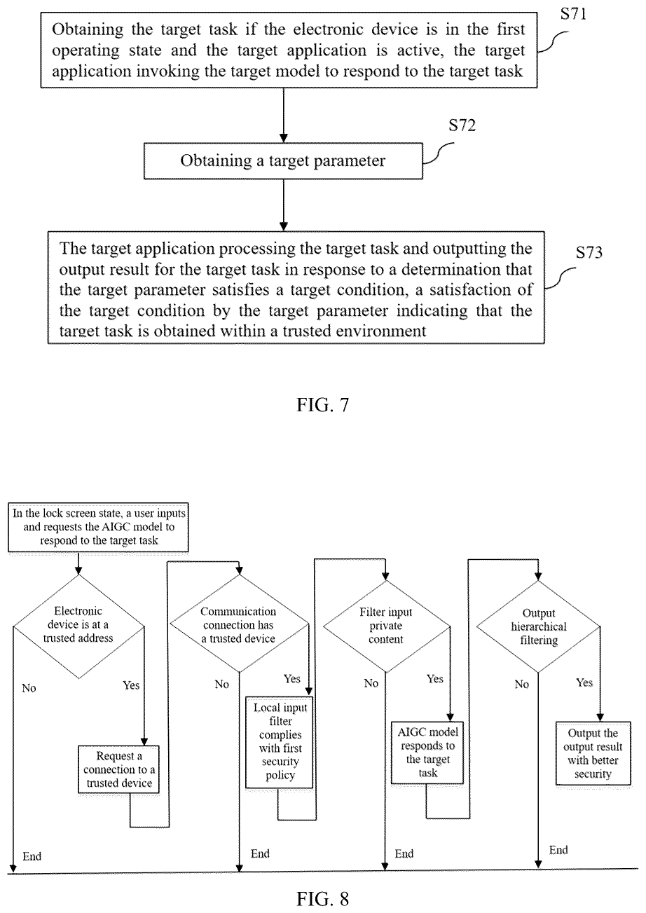

FIG. 7 illustrates a flowchart of a task processing method provided in Embodiment 7 of the present disclosure. Based on the task processing method described in any of the above embodiments, it is further possible to detect whether the electronic device obtains the target task within a trusted environment, and determine whether the electronic device is currently being used by an owner or another authorized user of the electronic device, thereby avoiding execution of the target task in an untrusted environment to enhance the security of task processing. Other steps of the task processing method may be implemented with reference to the corresponding embodiments described above and are not repeated herein.

Based on the above, as shown in FIG. 7, the task processing method proposed in Embodiment 7 may include but is not limited to the following steps.

S71: obtaining the target task if the electronic device is in the first operating state and the target application is active, the target application invoking the target model to respond to the target task.

S72: obtaining a target parameter.

S73: the target application processing the target task and outputting the output result for the target task in response to a determination that the target parameter satisfies a target condition, a satisfaction of the target condition by the target parameter indicating that the target task is obtained within a trusted environment.

In Embodiment 7, the target parameter may refer to a parameter associated with the electronic device, which is utilized to determine whether a process of obtaining the target task occurs in a trusted environment. The target parameter may be determined based on evaluation logic configured to determine whether the process of obtaining the target task is in a trusted environment. The target condition may also be determined based on evaluation logic. Different types of target parameters may involve different evaluation logic, resulting in different target conditions. The present disclosure does not limit the type of the target parameter, the method of obtaining the target parameter, or the corresponding target condition.

In practical applications, the target parameter may vary as the environment in which the electronic device obtains the target task changes. However, during a process of obtaining the target task, the target parameter of the electronic device remains relatively stable. Prior to responding to the target task, it may be determined based on the current target parameter of the electronic device whether the corresponding target condition is satisfied. Only when the target parameter is determined to meet the target condition can the target application running on the electronic device respond to the target task. As described in the above embodiments, the target model is invoked to respond to the target task, thereby ensuring that the output result is generated within a trusted environment, and reducing a risk of privacy leakage that may otherwise occur if the electronic device in the first operating state outputs the result in an untrusted environment.

In one possible implementation, the electronic device may store location information corresponding to one or more trusted environments, such as an owner's home address or a personal office address. The target parameter obtained by the electronic device may include location information of an environment in which the electronic device is currently situated, i.e., an environment in which the electronic device obtains the target task. It may be determined whether current location information matches any of stored trusted environment locations. If current location information of the electronic device matches the stored location information of any trusted environment, it may be determined that the process of obtaining the target task occurs in a trusted environment, that is, the target parameter meets the target condition. Accordingly, subsequent steps of the task processing method as described in Embodiment 7 may be carried out.

On the contrary, if the obtained location information does not match any of the trusted environment location information stored by the electronic device, it may be determined that the process of obtaining the target task occurs in an untrusted environment, i.e., a risk-prone environment in which privacy leakage is more likely to occur. To achieve privacy protection, the electronic device may directly prevent the target application from responding to the target task and, if necessary, output risk warning information to prompt an owner of the electronic device to verify a security state of the electronic device. An acquisition of the above location information may be accomplished using a location sensor of the electronic device. A specific implementation process is not described in detail in Embodiment 7. The present disclosure may also flexibly configure a format of the location information based on actual requirements, such as using latitude and longitude coordinates (e.g., a coordinate range for a trusted environment), street addresses, or layout positions of individual offices within an enterprise, to satisfy location matching requirements for various types of trusted environments.

In some embodiments, if the electronic device stores an identifier of one or more trusted devices bound thereto, the present disclosure does not limit an implementation method by which the electronic device binds the trusted device identifier based on user identity information. A determination of a trusted device may be based on the type of device and the communication method established between the trusted device and the electronic device. For example, trusted devices such as earphones or wristbands that communicate with the electronic device via Bluetooth may be authenticated through pairing. Upon successful pairing authentication, a binding is established between the electronic device and the earphones or wristbands. The electronic device may record a device identifier of a trusted device, such as a universally unique identifier (UUID) or a unique identifier configured by the electronic device for the bound trusted device, for example, a device number or device name. The present disclosure does not impose any limitation on the specific content of the device identifier.

Based on the above, the target parameter obtained by the electronic device may include the device identifier of at least one output device that is currently connected to the electronic device. For example, during a process of establishing communication connections between the electronic device and output devices, a device identifier of any output device that is successfully communicated with the electronic device may be determined and stored. Accordingly, after obtaining the target task, the electronic device may read the stored device identifiers of each connected output device. Alternatively, the electronic device may obtain device identifiers of the connected output devices by transmitting respective requests to each of the output devices. The present disclosure does not limit the method of obtaining device identifiers for the output devices communicatively connected to the electronic device.

The obtained device identifiers of all output devices communicatively connected to the electronic device may be compared with the stored device identifiers of trusted devices. If at least one device identifier matches, it is determined that a corresponding output device currently connected to the electronic device is a trusted device. The process of the electronic device obtaining the target task is considered to occur in a trusted environment, indicating that the target parameter meets the target conditions, and the target application is permitted to respond to the target task. Conversely, if the target parameter does not meet the target condition, the target application is prevented from responding to the target task, thereby reducing a risk of privacy leakage caused by loss, theft, or malicious use of the electronic device.

It can be seen that the present disclosure may utilize, but is not limited to, the various target parameters described above to determine whether the process of the electronic device obtaining the target task occurs within a trusted environment. As discussed above, location information of the trusted environment may be configured to reinforce a condition that the owner of the electronic device is currently present. A configuration of the location information of the trusted environment can be achieved by restricting, or even locking, a spatial range within which the target model is permitted to input or output private content in response to the target task. To further determine whether the electronic device is being used by an owner to perform the task processing method, and to verify a target condition of the owner's presence, as previously analyzed, the determination can also be implemented by verifying whether the electronic device is connected to a trusted device. By combining one or more implementation methods, it may be determined whether the electronic device obtains the target task within a trusted environment. If so, the target application is permitted to respond to the target task. Conversely, if it is determined that the electronic device is in a risky environment, the process is terminated immediately, and the response to the target task is prevented, thereby avoiding the risk of privacy leakage caused by outputting the result in an untrusted environment.

In conjunction with the description of the above target parameter, if the target parameter is determined not to meet the target condition, the response to the target task may be terminated, and invocation of the target model to process the task may be prevented.

Additionally, security level switching prompt information may be output to prompt a user to switch the electronic device to the second operating state, thereby increasing the security level of the electronic device before allowing the electronic device to respond to the target task. That is, in response to a state-switching operation input by the user, the electronic device may be controlled to switch from the first operating state to the second operating state. In the second operating state, the target model may continue to respond to the target task and generate the output result corresponding to an elevated security level associated with the second operating state.

In the task processing method described in each of the above embodiments, when it is necessary to output the output result for the target task, the obtained output result may be transmitted to an output device, such as an external device communicatively connected to the electronic device, or to an internal output device that is part of the electronic device. The corresponding output device outputs the output result for the target task. In a process of selecting an output device to output the output result, the output result may be transmitted to an output device that supports an output mode compatible with the data format of the output result, thereby ensuring reliable output of the output result for the target task. For example, if the output result includes display content such as text and/or image data, a display screen of the electronic device may be controlled to output the display content. If the output result includes audio data, an audio playback component of the electronic device or a Bluetooth headset communicatively connected to the electronic device may be controlled to play the audio content.

Optionally, based on the trusted environment determination method described above, if it is determined that the electronic device is operating in an environment deemed trustworthy by an owner, the output result for the target task may be delivered through an output device. The output device may include, but is not limited to, a display screen, audio player, or video player integrated into the electronic device, or an external output device located within the trusted environment and communicatively connected to the electronic device. When it is determined that the electronic device is communicatively connected to at least one trusted device, a trusted device having an output mode corresponds to a data format of the output result may be selected to output the output result. However, a manner in which the output result is implemented is not limited to the specific implementations described in the embodiments of the present disclosure.

In the implementation of the task processing method described in the above embodiments, after obtaining the output result for the target task, a security verification process may be performed prior to output. If the output result passes the security verification, the output result may be output using, but not limited to, the output methods described above. If the output result fails the security verification, a response to the target task may be terminated, an output of the result may be prevented, or a security level switching prompt message may be provided to a user, prompting the user to enhance the security level of the electronic device by switching the operating state of the electronic device. The output result corresponding to the updated security level (e.g., after switching to the second security level associated with the second operating state) may be output accordingly. A detailed implementation process is not described further in the present disclosure.

In practical applications, because a large-scale target model typically requires substantial computational resources to operate, running the target model locally on the electronic device may result in resource limitations, potentially causing the target model to fail or become unresponsive, thereby impacting an efficiency of the target model in processing the target task. To address the above issue, the target model may be deployed on a server. Accordingly, during execution, the electronic device may transmit the target task, or the target data required to perform the target task to the server. The server inputs the received target data into the target model, obtains the processing result, and returns the processing result to the electronic device. The electronic device, operating in the first operating state, outputs the output result in accordance with the first security level. The above task processing method conserves processing resources of the electronic device, ensures an efficient response to the target task, and maintains the security of the output result. However, the present disclosure is not limited to the specific implementation of invoking the target model to execute the target task as described above.

Based on the task processing methods described in the above embodiments, the security processing of the input and output ends of the target model, and the relevant descriptions of the electronic device in a trusted environment to obtain the target task, an example scenario is provided below. In the scenario, a user operates a mobile phone in the locked screen state to invoke an AIGC model to perform a task of summarizing unread email content. To ensure the security of the summarized email content to the greatest extent, the security processing methods described in the above embodiments may be integrated and applied.

Based on the above, and with reference to the flowchart of the task processing method shown in FIG. 8, when a mobile phone is in the locked screen state, and a user inputs a voice signal such as, “What's new in the mailbox?”. A voice assistant, operating on the electronic device, performs intent recognition on the voice signal to identify the target task requested by the user. The voice assistant invokes the AIGC model to respond to the target task. The AIGC model may further detect whether the electronic device is currently located within a trusted environment. As described above, whether the electronic device is operating in a trusted environment is determined based on current location information of the electronic device. If the electronic device is not in a trusted environment, the response process is terminated. If the electronic device is in a trusted environment, the electronic device may be requested to connect to a trusted device and determine whether the electronic device is communicatively connected to at least one trusted device. If no trusted device is detected, the response process is ended. If the device is connected to a trusted device, the obtained unread email content may be processed according to the first security policy. As shown in FIG. 8, the target data such as the unread email content may be input into a local input filter that complies with the first security policy. If sensitive content within the target data is successfully filtered out, the resulting secure data is provided to the target model. In response to the email content summarization task, the target model generates summarized email content.

Subsequently, the summarized email content may be subjected to hierarchical filtering based on the first security policy. If the summarized content contains private or sensitive information, security measures, such as filtering or blocking, can be applied. The mobile phone may output a more secure version of the summarized content while in the locked screen state. If the summarized result contains non-sensitive information, such as weather updates, calendar events, or social news, the corresponding content may be output directly without additional security processing.

In practical applications, when the mobile phone is in the locked screen state, a user can activate the voice assistant to call a client of the large AI model. By analyzing the voice signal input by the user, the mobile phone determines that the requested task is a target task requiring execution via the large AI model. The present disclosure can still respond to the target task and output requested reply content at the security level corresponding to the locked screen state of the electronic device, that is, the output result, without requiring the user to unlock the mobile phone, thereby improving a user experience. Moreover, since the output result corresponds to a lower security level in the locked screen state, applying appropriate security policies can effectively reduce a risk of private content leakage.

The above describes a task processing method provided by the embodiments of the present disclosure. The following will introduce a device for executing the above task processing method.

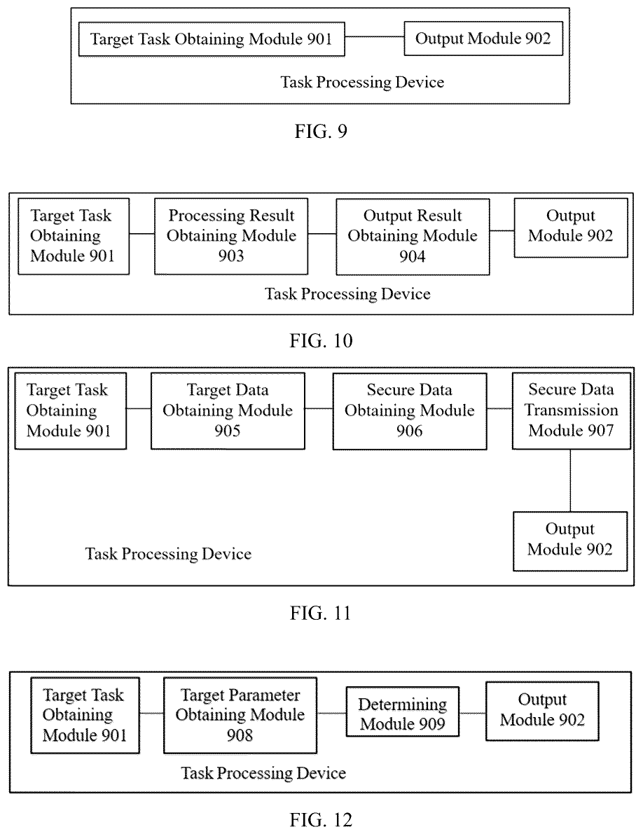

FIG. 9 illustrates a schematic diagram of a task processing device provided in Embodiment 1 of the present disclosure. As shown in FIG. 9, the task processing device may include: a target task obtaining module 901, configured to obtain a target task if an electronic device is in a first operating state and a target application is active, the target application being capable of invoking a target model to respond to the target task; and an output module 902, configured to output an output result for the target task by the target application in response to the target task.

The output result corresponds to a security level corresponding to the first operating state of the electronic device. A security level of the electronic device in the first operating state is lower than a security level of the electronic device in a second operating state.

In a potential implementation, as shown in FIG. 10, the task processing device may further include: a processing result obtaining module 903, configured to obtain a processing result of the target model in response to the target task; and an output result obtaining module 904, configured to process the processing result based on a first security policy and obtaining the output result.

The first security policy corresponds to the security level of the electronic device in the first operating state. Semantics represented by the output result are identical to semantics represented by the processing result, and a security of the output result is higher than a security of the processing result.

In a potential implementation, as shown in FIG. 11, the task processing device may further include: a target data obtaining module 905, configured to obtain target data; a secure data obtaining module 906, configured to process the target data based on the first security policy to obtain secure data, the first security policy corresponding to a security level of the electronic device in the first operating state, and a security of the secure data being higher than a security of the target data; and a secure data transmission module 907, configured to transmit the secure data to the target model, so that the target model responds to the target task based on the secure data.

In one potential implementation, as shown in FIG. 12, the task processing device may further include: a target parameter obtaining module 908, configured to obtain a target parameter; and a determining module 909, configured to trigger the output module 902 to execute the target application in response to the target task and output the output result if the target parameter is determined to meet a target condition. Determining that the target parameter satisfies the target condition may indicate that a process of obtaining the target task is performed in a trusted environment.

Optionally, the determination module 909 may include at least one of: a first determination unit, configured to determine, when the target parameter includes location information of an environment in which the electronic device is located, whether the location information matches location information of a trusted environment stored by the electronic device; and a second determination unit, configured to determine, when the target parameter includes a device identifier of at least one output device communicatively connected to the electronic device, whether the device identifier matches a device identifier of a trusted device bound to the electronic device.

Optionally, the output module 902 may include: a configuration unit, configured to configure the target model based on a first configuration parameter, so that the target model responds to the target task based on feature information of a public knowledge base; and an output unit, configured to output the output result for the target task. The first configuration parameter corresponds to a security level of the electronic device in the first operating state. A security of the output result generated by the target model in response to the target task based on feature information of the public knowledge base is higher than a security of the output result generated by the target model in response to the target task based on feature information of a personal knowledge base.

In practice, the first security policy may include at least one of the following: a filtering policy based on a sensitive lexicon, configured to prevent the output result from containing sensitive words included in the sensitive lexicon; an anonymization processing policy, configured to mask user information and device information, thereby preventing the output result from containing device-specific or user-specific information of the electronic device; and a privacy protection policy based on differential privacy technology.

Optionally, the task processing device may further include: a verification module, configured to perform security verification on the output result; an end module, configured to terminate a response to the target task and preventing output of the output results for the target task if a security check result fails; and optionally, a prompt information output module, configured to output prompt information for switching the security level, to control the electronic device to switch from the first operating state to the second operating state in response to a user input. The target model responds to the target task and outputs the output result for the target task corresponding to the security level of the electronic device in the second operating state.

One embodiment provides a computer program product including computer-readable instructions which, when executed by an electronic device, cause the electronic device to perform any of the task processing methods described in the embodiments of the present disclosure.

When the computer-readable instructions are loaded and executed on a computer, the computer-readable instructions cause the processes or functions described in the embodiments of the present application to be implemented, in whole or in part. The computer may be a general-purpose computer, a special-purpose computer, a computer network, or another programmable device. The computer-readable instructions may be stored in or transmitted from one computer-readable storage medium to another computer-readable storage medium.

One embodiment provides a computer-readable storage medium storing one or more computer programs which, when executed by an electronic device, cause the electronic device to perform any of the task processing methods described in the embodiments of the present disclosure.

The computer-readable storage medium may include any available medium on which a computer can store data, or a data storage system such as a data center integrated with one or more such media. Examples of available media include magnetic media (e.g., floppy disks, hard disks, magnetic tapes), optical media (e.g., DVDs), and semiconductor media (e.g., solid-state drives (SSDs)).

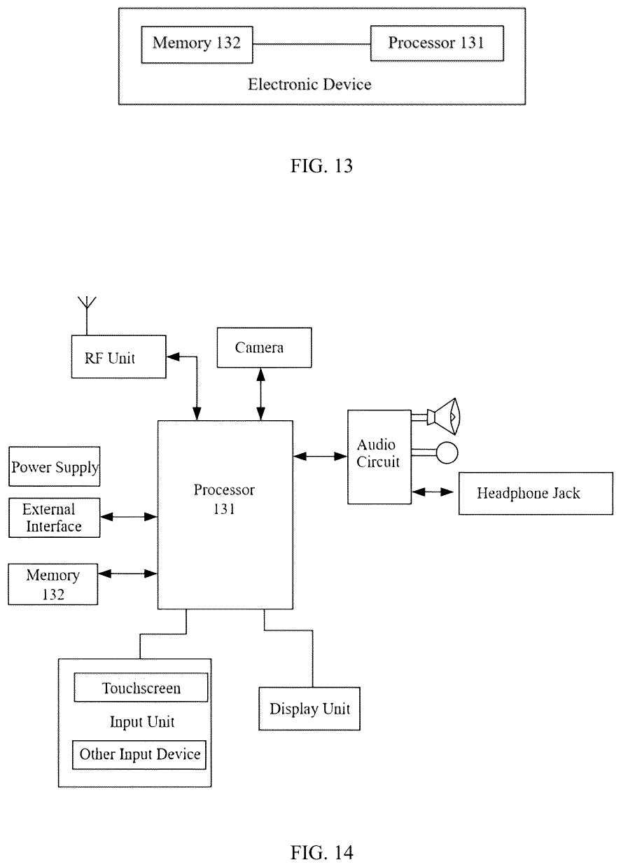

FIG. 13 illustrates a schematic diagram of a hardware structure of an electronic device provided in Embodiment 1 of the present disclosure. As shown in FIG. 13, the electronic device may include at least one processor 131 and at least one memory 132. The at least one processor 131 and the at least one memory 132 may communicate via a bus, which may be a peripheral component interconnect (PCI) bus, an extended industry standard architecture (EISA) bus, or another suitable bus. The bus may include an address bus, a data bus, a control bus, or any combination thereof. For simplicity, only a single thick line is illustrated in FIG. 13, which does not imply that the electronic device includes only one bus or a single type of bus.

The memory 132 may store computer program instructions for implementing the task processing method described in the embodiments of the present disclosure, as well as program code supporting an operation of the target application. The processor 131 may load and execute the computer program instructions stored in the memory 132 to implement the task processing method according to a corresponding embodiment. For details regarding the implementation process, reference may be made to the description of a corresponding method embodiment described above.

In one embodiment, the processor 131 may include one or more processing units, such as any one or more of a central processing unit (CPU), a graphics processing unit (GPU), a microprocessor (MP), a digital signal processor (DSP), a hardware circuit such as an application-specific integrated circuit (ASIC), a field-programmable gate array (FPGA), a modem processor, or the like.

The memory 132 may be a non-volatile memory, such as a hard disk drive (HDD) or a solid-state drive (SSD), or a volatile memory, such as random-access memory (RAM). The memory may include, but is not limited to, any medium capable of carrying or storing program code in the form of instructions or data structures that can be accessed by a computer. In one embodiment, the memory 132 may also be implemented as a circuit or any other device capable of performing a storage function for storing program instructions and/or data.

In practical applications, to enable communication between the electronic device and external devices (such as output devices or servers), the electronic device may include wireless communication components supporting one or more communication standards or protocols, as well as wired communication components, such as serial ports, parallel ports, or one or more types of USB interfaces.

A structure of the electronic device shown in FIG. 13 does not limit the electronic device in the embodiments of the present application. In practical applications, the electronic device may include additional components beyond the components shown in FIG. 13 or may integrate certain components. As shown in FIG. 14, the electronic device may also include a display unit, configured to display the output result for the target task, various prompt information, and the like; a voice pickup device, configured to collect voice signals input by a user; a speaker; various sensors; a power module; and a radio frequency unit, configured to send and receive information. The electronic device may include, for example, an antenna; one or more amplifiers; a transceiver; a coupler; a low noise amplifier (LNA); a duplexer, configured to enable data transmission between the electronic device and a base station; various communication components; external ports; and input/output units, such as a touch screen, mouse button, function button, joystick, or trackball. The specific components may be selected based on processing function requirements and are not limited to the components explicitly listed herein.

It should be noted that the device embodiments described above are illustrative only. Units described as separate components may or may not be physically separated. The components shown as units may be implemented as physical units located at a single location or distributed across a plurality of network units. Some or all of the modules may be selected as needed to achieve objectives of the embodiments. Furthermore, in the accompanying drawings of the device embodiments, connections between modules indicate communication links, which may be implemented as one or more communication buses or signal lines.

From the above description of the embodiments, a person skilled in the art can readily understand that the present disclosure may be implemented by software in combination with necessary general-purpose hardware. Alternatively, the present disclosure may be implemented by dedicated hardware, including dedicated integrated circuits, dedicated CPUs, dedicated memories, dedicated components, or any combination thereof. The embodiments may be implemented wholly or partially by software, hardware, firmware, or any combination thereof. When implemented in software, the implementation may take the form of a computer program product, in whole or in part.

As disclosed, the task processing method, the tasking processing device and the electronic device provided by the present disclosure at least realize the following beneficial effects.

The task processing method enables a target application to invoke a target model to respond to a target task and fulfill a user's task processing needs when an electronic device is in a low-security operating state, such as a screen lock state. Meanwhile, the method ensures that the output result of the electronic device for the target task corresponds to a lower security level. Under the lower security level, the processing content of the target task is restricted to prevent the output of sensitive user or device information, or other predetermined important data.

Accordingly, the method maintains security while fulfilling task processing needs and improving the user experience.

Each embodiment described in the present specification is presented in a progressive manner, focusing on differences from other embodiments. Identical or similar components among various embodiments may be cross-referenced. Since the devices and electronic equipment disclosed in the embodiments correspond to the methods described, the descriptions of the devices and electronic device are simplified. For additional details, reference may be made to the corresponding method descriptions.

What is claimed is:

1. A task processing method, comprising:
obtaining a target task in response to an electronic device being in a first operating state and a target application being active, wherein the target application calls a target model to respond to the target task; and
in response to the target task, outputting an output result for the target task by the target application, wherein:
the output result corresponds to a security level of the electronic device in the first operating state; and
the security level of the electronic device in the first operating state is lower than a security level of the electronic device in a second operating state.

2. The method according to claim 1, further comprising, before outputting the output results for the target task:
obtaining a processing result of the target model in response to the target task; and
processing the processing result based on a first security policy to obtain the output result, wherein:
the first security policy corresponds to a security level of the electronic device in the first operating state; and
semantics represented by the output result is identical to semantics represented by the processing result and a security of the output result is higher than a security of the processing result.

3. The method according to claim 1, further comprising, before the target model obtains target data required to respond to the target task:
obtaining the target data;
processing the target data based on a first security policy to obtain secure data, wherein the first security policy corresponds to a security level of the electronic device in the first operating state, and a security of the secure data is higher than a security of the target data; and
providing the secure data to the target model such that the target model responds to the target task based on the secure data.

4. The method according to claim 1, wherein:
in response to the target task, the target application configures the target model based on a first configuration parameter so that the target model responds to the target task based on feature information of a public knowledge base;
the first configuration parameter corresponds to a security level of the electronic device in the first operating state; and
a security level of an output result generated by the target model based on feature information of the public knowledge base is higher than a security level of an output result generated by the target model based on feature information of a personal knowledge base.

5. The method according to claim 1, further comprising, before the target application responds to the target task and outputs the output result for the target task:
obtaining a target parameter;
in response to a determination that the target parameter satisfies a target condition, outputting the output result for the target task by the target application, wherein the determining that the target parameter satisfies the target condition indicates that a process of obtaining the target task is performed in a trusted environment.

6. The method according to claim 2, wherein the first security policy includes at least one of the following:
a filtering policy based on a sensitive lexicon, configured to prevent the output result from containing sensitive words included in the sensitive lexicon;
an anonymization processing policy, configured to mask user information and device information to prevent the output result from containing the user information and device information of the electronic device; and
a privacy protection policy based on differential privacy technology.

7. The method according to claim 3, wherein the first security policy includes at least one of:
a filtering policy based on a sensitive lexicon, configured to prevent the output result from containing sensitive words included in the sensitive lexicon;
an anonymization processing policy, configured to mask user information and device information, thereby preventing the output result from containing the user information and device information of the electronic device; and
a privacy protection policy based on differential privacy technology.

8. The method according to claim 5, wherein determining that the target parameter satisfies the target condition includes at least one of:
determining that, in response to the target parameter including location information of an environment in which the electronic device is located, the location information matches location information of a trusted environment stored by the electronic device; and
determining that, in response to the target parameter including a device identifier of at least one output device communicatively connected to the electronic device, the device identifier matches a device identifier of a trusted device bound to the electronic device.

9. The method according to claim 1, further comprising, before outputting the output result for the target task:
performing a security verification on the output result; and
in response to that the security verification result fails, performing one of:
terminating the response to the target task to prevent outputting the output result;
or
outputting a security level switching prompt to control the electronic device to switch from the first operating state to the second operating state in response to an operating state switching operation input by a user, such that the target model responds to the target task and outputs the output result corresponding to the security level of the electronic device in the second operating state.

10. An electronic device, comprising:
one or more processors and at least one memory containing computer program instructions for executing a target application, wherein when executing the computer program instructions, the one or more processors are configured to perform:
obtaining a target task in response to an electronic device being in a first operating state and a target application being active, wherein the target application calls a target model to respond to the target task; and
in response to the target task, outputting an output result for the target task by the target application, wherein:
the output result corresponds to a security level of the electronic device in the first operating state; and
the security level of the electronic device in the first operating state is lower than a security level of the electronic device in a second operating state.

11. The electronic device according to claim 10, wherein the one or more processors are further configured to perform:
obtaining a processing result of the target model in response to the target task; and
processing the processing result based on a first security policy to obtain the output result, wherein:
the first security policy corresponds to a security level of the electronic device in the first operating state; and
semantics represented by the output result is identical to semantics represented by the processing result and a security of the output result is higher than a security of the processing result.

12. The electronic device according to claim 10, wherein the one or more processors are further configured to perform:
obtaining the target data;
processing the target data based on a first security policy to obtain secure data, wherein the first security policy corresponds to a security level of the electronic device in the first operating state, and a security of the secure data is higher than a security of the target data; and
providing the secure data to the target model such that the target model responds to the target task based on the secure data.

13. The electronic device according to claim 10, wherein:
in response to the target task, the target application configures the target model based on a first configuration parameter so that the target model responds to the target task based on feature information of a public knowledge base;
the first configuration parameter corresponds to a security level of the electronic device in the first operating state; and
a security level of an output result generated by the target model based on feature information of the public knowledge base is higher than a security level of an output result generated by the target model based on feature information of a personal knowledge base.

14. The electronic device according to claim 10, wherein the one or more processors are further configured to perform:
obtaining a target parameter;
in response to a determination that the target parameter satisfies a target condition, outputting the output result for the target task by the target application,
wherein the determining that the target parameter satisfies the target condition indicates that a process of obtaining the target task is performed in a trusted environment.

15. The electronic device according to claim 11, wherein the first security policy includes at least one of the following:
a filtering policy based on a sensitive lexicon, configured to prevent the output result from containing sensitive words included in the sensitive lexicon;
an anonymization processing policy, configured to mask user information and device information to prevent the output result from containing the user information and device information of the electronic device; and
a privacy protection policy based on differential privacy technology.

16. The electronic device according to claim 12, wherein the first security policy includes at least one of:
a filtering policy based on a sensitive lexicon, configured to prevent the output result from containing sensitive words included in the sensitive lexicon;
an anonymization processing policy, configured to mask user information and device information, thereby preventing the output result from containing the user information and device information of the electronic device; and
a privacy protection policy based on differential privacy technology.

17. The electronic device according to claim 14, wherein the one or more processors are further configured to perform at least one of:
determining that, in response to the target parameter including location information of an environment in which the electronic device is located, the location information matches location information of a trusted environment stored by the electronic device; and
determining that, in response to the target parameter includes a device identifier of at least one output device communicatively connected to the electronic device, the device identifier matches a device identifier of a trusted device bound to the electronic device.

18. A non-transitory computer readable storage medium containing computer program instructions for executing a target application, wherein when executing the computer program instructions, at least one processor is configured to perform:
obtaining a target task in response to an electronic device being in a first operating state and a target application being active, wherein the target application calls a target model to respond to the target task; and
in response to the target task, outputting an output result for the target task by the target application, wherein:
the output result corresponds to a security level of the electronic device in the first operating state; and
the security level of the electronic device in the first operating state is lower than a security level of the electronic device in a second operating state.

19. The storage medium according to claim 18, wherein the at least one processor is further configured to perform:
obtaining a processing result of the target model in response to the target task; and
processing the processing result based on a first security policy to obtain the output result, wherein:
the first security policy corresponds to a security level of the electronic device in the first operating state; and
semantics represented by the output result is identical to semantics represented by the processing result and a security of the output result is higher than a security of the processing result.

20. The storage medium according to claim 18, wherein the at least one processor is further configured to perform:
obtaining the target data;
processing the target data based on a first security policy to obtain secure data, wherein the first security policy corresponds to a security level of the electronic device in the first operating state, and a security of the secure data is higher than a security of the target data; and
providing the secure data to the target model such that the target model responds to the target task based on the secure data.
